(19) United States
(12) Patent Application Publication
(10) Pub. No.: US 2025/0258879 A1
(43) Pub. Date: Aug. 14, 2025

(54) METHOD AND SYSTEM FOR AN INNOVATION INTELLIGENCE PLATFORM

(71) Applicant: FLUIDITYIQ, LLC, Marion, MA (US)

(72) Inventors: Jeffrey L. Roy, Marion, MA (US); Eric Pinstein, Winchester, MA (US); Carlo Romero, New York City, NY (US); James Cairns, Andover, MA (US)

(21) Appl. No.: 19/048,125

(22) Filed: Feb. 7, 2025

Related U.S. Application Data
(60) Provisional application No. 63/551,712, filed on Feb. 9, 2024.

(51) Int. Cl. G06F 16/9535; G06N 5/04

(52) U.S. Cl. CPC G06F 16/9535; G06N 5/04

(57) ABSTRACT

A system and method of establishing and curating data. The method includes maintaining a knowledge base in a digital library to support an information-based decision-making process. The knowledge base is dynamically maintained by using an embedding model for indexing a plurality of data sets, and conducting at least one search over the plurality of data sets to identify one or more documents, the documents stored in the digital library.

### CROSS-REFERENCE TO RELATED APPLICATIONS

This application claims priority from U.S. Provisional Patent Application 63/551,712, filed Feb. 9, 2024, which is hereby incorporated herein by reference in its entirety.

### TECHNICAL FIELD

The present invention relates to a methodology and system for data curation to support information-based decisions, and more particularly, to dynamically populating a knowledge base using, in part, an embedding model for indexing a plurality of data sets.

### BACKGROUND ART

Creating targeted intelligence in support of a decision-making process has always been difficult and time consuming, regardless of the industry. While data processing and database tools have certainly improved over time, the amount of data being created by companies, regulators and individuals is far outpacing the development of new tools to successfully process this data and generate targeted intelligence that is fit for purpose. The total amount of data created, captured, copied, and consumed globally is forecast to increase rapidly, from approximately 64.2 zettabytes in 2020 to over 180 zettabytes by 2025, a 180% increase in just five years. See Amount of data created, consumed, and stored 2010-2020, with forecasts to 2025, Petroc Taylor, Nov. 16, 2023. Sourced from Statista.

FIG. 1 shows a typical search methodology. Initially, a researcher creates a Boolean search query 101 to establish a syntax, which is ultimately used to perform a search on the Internet 103. This requires the researcher to have both some expertise in creating Boolean searches and a basic understanding of the data they are seeking. In many ways, generations of researchers have been trained by internet search engines to search in specific ways and we have become accustomed to receiving rendered results as a linear list 105 that we then need to peruse 107 to identify relevant information for our specified purpose. We must do this without a clear understanding of how search engines prioritize results and calculate relevance. When a large amount of data is involved, this can be difficult if not impossible. The researcher may then have to enter a new Boolean string 109 and conduct further searches 111, which may again yield a large amount of results 113 that are different, or that may overlap, that will again have to be perused 107.

As a result, research has become a process that sometimes involves many steps in order to get the query right, and then many more steps and much work to curate the data down to relevant results that can support a specific business decision. Importantly, a search is typically a transaction that is only relevant at the specific point in time that rendered results are presented to the user. Since data is “liquid” and continually updated, as time moves forward the specified query loses relevance.

With the advent of new artificial intelligence (AI) tools, the problem is growing and not shrinking as one might think. Generative AI not only results in the faster creation of new data and content thereby exacerbating the data proliferation problem, it also can create inaccurate intelligence based on what information is used to train the underlying model. This false intelligence can take many forms, including the presentation of a “hallucination”, or misleading information that can seem plausible to the researcher, or can have a bias of some kind represented in the data that is not clear to the researcher. Making good decisions based on available data intelligence is getting harder, not easier.

### SUMMARY OF THE EMBODIMENTS

In accordance with an embodiment of the invention there is provided a computer-implemented method of establishing and curating data for a user-defined purpose. The method includes maintaining a knowledge base in a digital library to support an information-based decision-making process or to advance research. The knowledge base is dynamically maintained by using an embedding model for indexing a plurality of data sets, and conducting at least one search over the plurality of data sets to identify one or more documents, the documents stored in the digital library.

In accordance with related embodiments of the invention, wherein the at least one search may be conducted intermittently or periodically. A user project profile and/or documentation may be received, at a user interface, wherein conducting the at least one search includes constructing a query over the plurality of data sets based on the contextual data associated with the user project profile and/or documentation. Conducting the at least one search may include utilizing contextual data from documents already stored in the digital library to construct a query that may be new, or an updated version of an existing query, over the plurality of data sets. Relevance indicators may be received from a user interface, wherein conducting the at least one search includes fine tuning a query over the plurality of data sets based on the relevance indicators. Using the embedding model for indexing a plurality of datasets may include creating a single representative index of the documents stored in the digital library.

The method may further include utilizing a large language model (LLM) that interacts with a user interface to evaluate information stored within the digital library to ensure that data found by the searches is relevant to the contents of the digital library and/or aid in formation of queries.

In accordance with another embodiment of the invention, a system for establishing and curating data for a user-defined purpose is provided. The system includes a server configured to maintain a knowledge base in a digital library to support an information-based decision-making process or to advance research. The server is configured to dynamically populate the knowledge base by using an embedding model for indexing a plurality of data sets, and conducting at least one search over the plurality of data sets to identify one or more documents, the documents stored in the digital library.

In accordance with related embodiments of the invention, the server may be configured to conduct the at least one search intermittently or periodically. The server may be further configured to receive, at a user interface, a user project profile and/or documentation, wherein conducting the at least one search includes constructing a query over the plurality of data sets based on the contextual data associated with the user project profile and/or documentation. In conducting the at least one search, the server may be configured to utilize contextual data from documents already stored in the digital library to construct a query that may be new, or an updated version of an existing query, over the plurality of data sets. The server may be further configured to receive relevance indicators from a user interface, wherein conducting the at least one search includes fine tuning a query over the plurality of data sets based on the relevance indicators. The server may be configured to create a single representative index of the documents stored in the digital library. The server may be further configured to utilize a large language model (LLM) that interacts with a user interface to evaluate information stored within the digital library to ensure that data found by the searches is relevant to the contents of the digital library and/or aid in formation of queries.

In accordance with another embodiment of the invention, a computer program product for establishing and curating data for a user-defined purpose is provided. The computer program product includes a non-transitory computer usable medium having computer readable program code thereon. The computer readable program code includes program code for maintaining a knowledge base in a digital library to support an information-based decision-making process or advance research. The program code may further include program code for dynamically populating the knowledge base by using an embedding model for indexing a plurality of data sets, and conducting at least one search over the plurality of data sets to identify one or more documents, the documents stored in the digital library.

In accordance with related embodiments of the invention, conducting the at least one search may be performed intermittently or periodically. The computer program product may further include program code for receiving, at a user interface, a user project profile and/or documentation, wherein conducting the at least one search includes constructing a query over the plurality of data sets based on the contextual data associated with the user project profile and/or documentation. The computer program product may conduct the at least one search includes utilizing contextual data from documents already stored in the digital library to construct a query that may be new, or an updated version of an existing query, over the plurality of data sets. The computer program product may further include program code for receiving relevance indicators from a user interface, wherein conducting the at least one search includes fine tuning a query over the plurality of data sets based on the relevance indicators. Using an embedding model for indexing a plurality of datasets may include creating a single representative index of the documents stored in the digital library. The computer program product may further include program code for utilizing a large language model (LLM) that interacts with a user interface to evaluate information stored within the digital library to ensure that data found by the searches is relevant to the contents of the digital library and/or aid in formation of queries.

### BRIEF DESCRIPTION OF THE DRAWINGS

The foregoing features of embodiments will be more readily understood by reference to the following detailed description, taken with reference to the accompanying drawings, in which:

FIG. 1 shows a typical prior art search methodology;

FIG. 2 shows a Private Innovation Library (PIL) methodology, in accordance with an embodiment of the invention;

FIG. 3 shows a block flow diagram for updating a PIL, in accordance with an embodiment of the invention;

FIG. 4 is a block flow diagram illustrating components of a system, in which various embodiments of the invention may be employed;

FIG. 5 is a block flow diagram of a PIL system, in accordance with an embodiment of the invention;

FIG. 6 is a block flow diagram showing how patent claims may be vectorized, in accordance with an embodiment of the invention;

FIG. 7 shows a block flow diagram of a PIL interrogation by a user, in accordance with an embodiment of the invention; and

FIG. 8 is a block flow diagram of hallucination detection in a query response, in accordance with an embodiment of the invention.

### DETAILED DESCRIPTION OF SPECIFIC EMBODIMENTS

In illustrative embodiments, an AI-based process and system gives users the ability to establish and curate a secure domain-specific knowledge base that more easily and accurately supports an information-based decision-making process or analysis. A dynamically curated library, referred to herein as a “Private Innovation Library” (PIL) is created. In doing so, embedded logic is developed that streamlines an intelligent search via the vectorization process. A Large Language Model (LLM) is utilized as a user interface where the user may interrogate rendered search results in natural language. Boundaries for the Large Language Model (LLM) are created to ensure that user queries remain in context. Importantly, the PIL includes a contextual engine that dynamically prioritizes, organizes, and presents search results from one or more databases in a topical fashion that leverages proximity, frequency and other means to determine relevance to the user. The PIL may include a project profile component that enables users to pre-set certain priorities to help minimize the challenges associated with other LLM-based models that could return too much data.

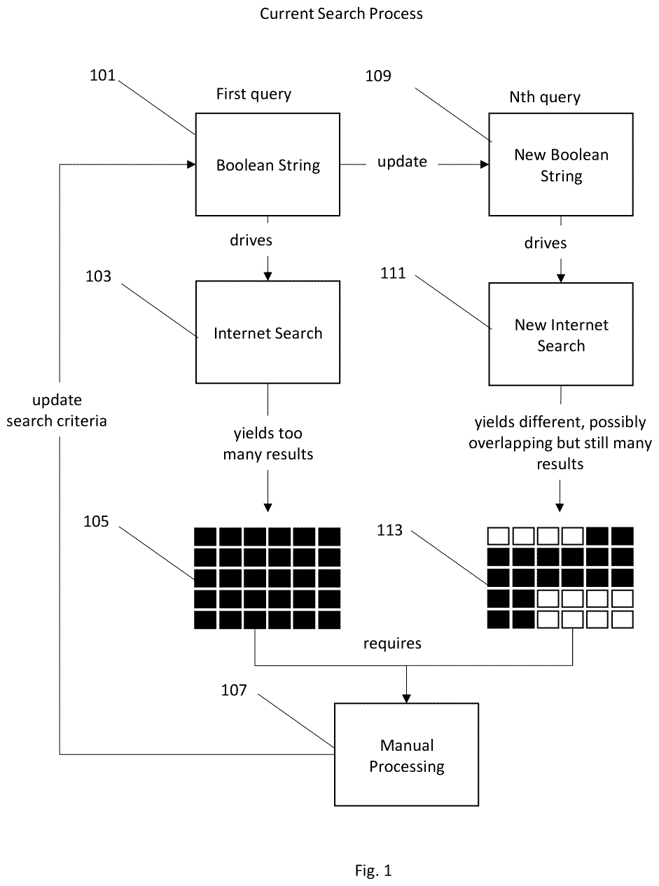

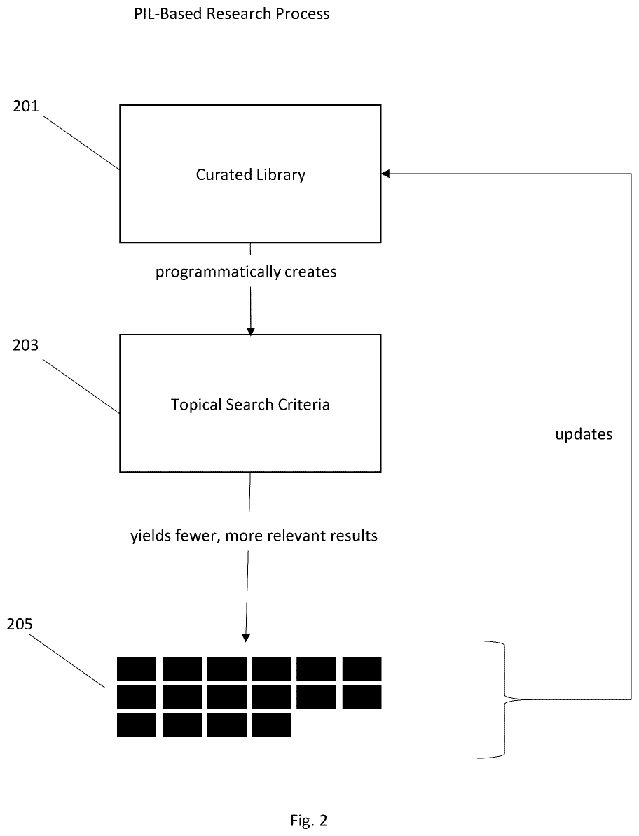

FIG. 2 shows a PIL methodology, in accordance with an embodiment of the invention. Compared to the prior art shown in FIG. 1, based on a dynamic, curated library 201, a topical search query 203 may be programmatically created, ensuring that any set of queries are based on only relevant information. The environment also leverages rendered results 205 to improve future research thereby increasing the fidelity of a research project while also streamlining the ongoing effort to produce and manage output. Since the curated library 201 is dynamic, it does not lose relevance as time moves forward.

The PIL system 200 is at its core a robust method for building dynamically updated, user-curated, contextual intelligence platforms to support specific analytical purposes. The functions of the PIL system 200 includes leveraging contextual data loaded into the PIL environment to construct queries that will be used to extract intelligence from a specific target database or research library.

The PIL system 200 may advantageously be utilized by users who need to build intelligence from publicly available patent data. The curated library may thus be based on global patent filings. That said, the PIL queries may also be aimed at other research platforms that are fit for other purposes, such as a library of cancer or economic research.

Each PIL may be constrained by its own purpose. In this manner, searches will be dominated by solutions based on fit-for-purpose domain databases with more targeted interfaces. Researchers want to process ever larger amounts of data faster and cannot necessarily rely on “black boxes” to do their work.

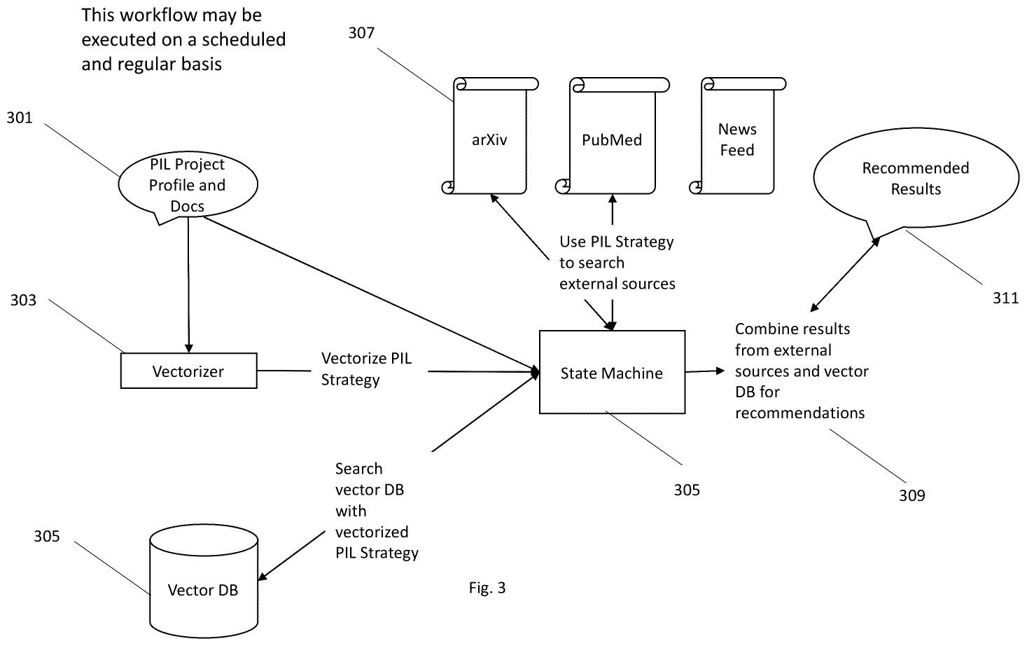

FIG. 3 shows a block flow diagram of creating and updating a PIL, in accordance with an embodiment of the invention. For example, if a user is performing a patentability search for a specific feature of their company's products, they would first build a PIL project profile 301 describing the criteria and relevant features of their products. They would also load documents, such as product specifications and research papers, et al into the PIL to help build context for their patent searches. If the product is broad and has many features, the user might choose to create multiple PILs to support different types of queries where one PIL instance might be equal to a set of product features. In various embodiments, a user may create multiple search strategies for different claim types all within one library for a single invention (i.e., many features of one tool).

The PIL project profile/provided documents 301 are vectorized 303. A controller/state machine 305 within the PIL system may then construct a series of search criteria 303 based on the vectorized PIL profile/documents 303 and may (or may not) recommend the search criteria 303 to the user for editing. Upon approval (if needed), the search criteria would be used to search for relevant data from both the external databases 307 and the vector database 305 (i.e., representing relevant data that already may be in the PIL library based on, for example, prior searches or user entry). The combined results 309 are presented to the user. The user may then select from the recommended results 311 those documents/vectors to be stored in or removed from the PIL, which may then be further used to inform the PIL when performing further searches. Further searches may be performed in a manual or automatic, intermittent or periodic fashion. The user may then produce reports, summaries or ask questions of the Large Language Model (LLM) associated with the PIL, via, without limitation, a generative AI interface to further their research.

In this way, the PIL-based solution provides two major advantages over other solutions available in the market today: 1. a programmatically constructed and concise search query string based on a curated knowledge library; and 2. a dynamically updated environment ensuring that the research results and any reporting will be updated and not constrained by the point in time that it was created.

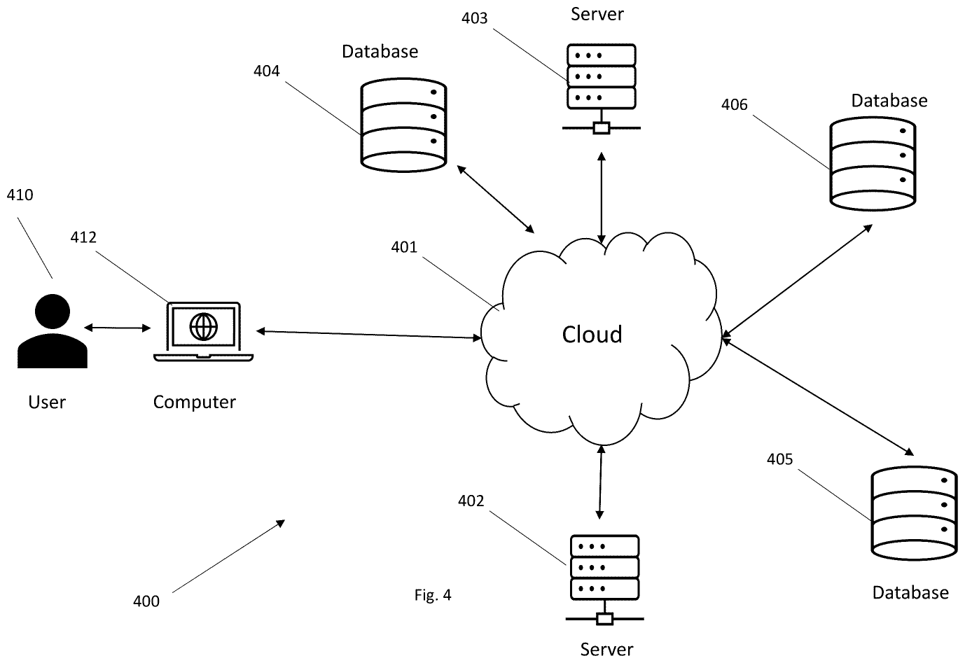

FIG. 4 is a block diagram illustrating components of a system 400, in which various embodiments of the invention may be employed. The system 400 may include a cloud 401 which may be operatively connected to one or more servers 402, 403. The cloud 401 may be the Internet and/or include various local area networks. Servers 402, 403 may include one or more computers/processors which can access local memory/databases. Alternatively, or in addition to the local memory, a server 402, 403 may have access to any number of databases 404-406 on the cloud 401. A user 410 of the system 400 may be able to access the cloud via a user interface 412, which may be computer with associated keyboard, mouse and/or display (which may be a touch panel). It is to be understood that the functionality of the PIL system 400 may be spread across any number of servers, databases, and user interfaces. For example, the curated digital library that stores the domain-specific knowledge base, and the external data sets that are searched, may be stored on any one of the various databases operatively coupled to the cloud and or/local memory. Applications/program code/software application(s) and/or state controller(s) associated with the PIL system 400, and that may control various factions within the PIL system 400, may exist at one or more of the servers 402, 403 and databases 404-406. Illustratively, a Large Language Model (LLM) may reside on one server, Artificial Intelligence on another server, and a state controller on another server. The user 410 may interface with the PIL system 400 through the user interface 410.

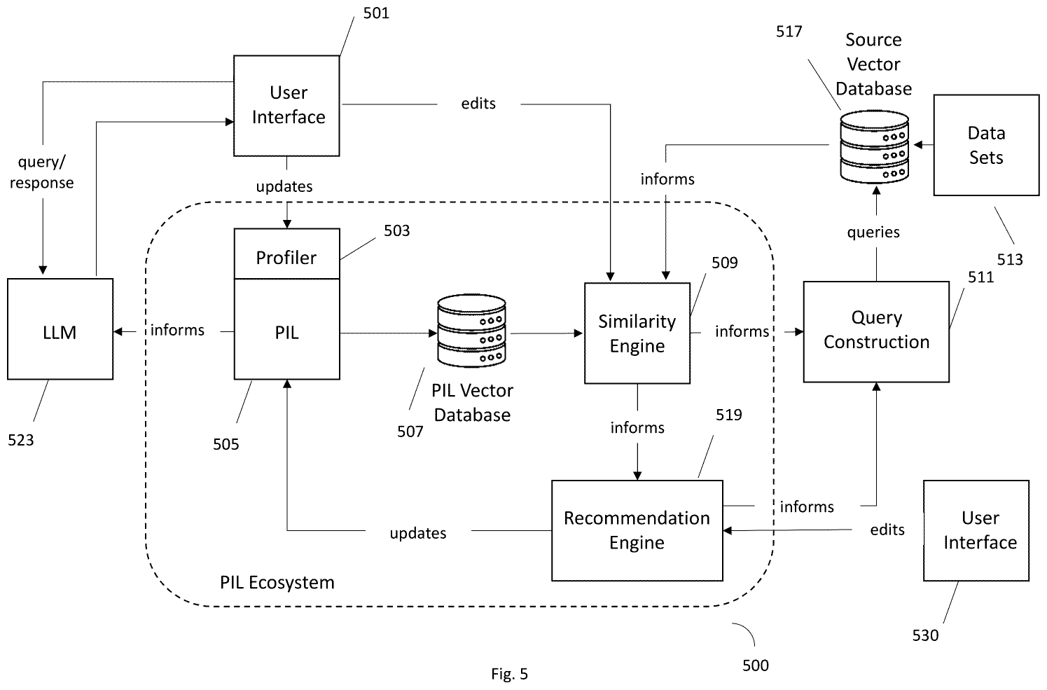

FIG. 5 is a block flow diagram of a PIL system 500, in accordance with an embodiment of the invention. Users at a user interface 501 may create project profiles 503 to guide recommendations for query construction and additionally, may provide additional relevant documentation such as, without limitation, specifications, regulations, news and articles. The project profile 503 is typically an integral part of the PIL 505 and sets user priorities for a given research project.

The PIL 505 is a contextual library of information gleaned from the profile 503 and the various documents, news/journals, internal product specifications, regulatory filings, etc. loaded into the PIL 505 because of their topical relevance. The PIL 505 may be updated, without limitation, in two ways: first, building the contextual library in this step using project profiles 501 and other documentation provided by the user, and later the population of the PIL with regulatory or other data via searches of one or more relevant data sets 513, such as a patent data set, in order to build a dynamically updated domain-specific library to support decision making, such as patent searching, investment analysis, R&D, competitive intelligence and more.

Information in the PIL 505 may be parsed, tokenized and converted into vectors, which are stored in a database 507. Illustratively, an embedding model may convert english words into a set of floating point numbers. Those numbers may then be inserted into vector database and indexed in such a way that the vectors can be searched using similarity scores. The similarity engine 509 may calculate the relevance of various semantic information in the PIL vector database and create query criteria. More particularly, semantic information from the PIL vector database may be ranked and used to construct contextual queries 511 that can be used in a research project to identify the universe of relevant information required in response to future domain-specific queries to be asked by the user/Large Language Model (LLM).

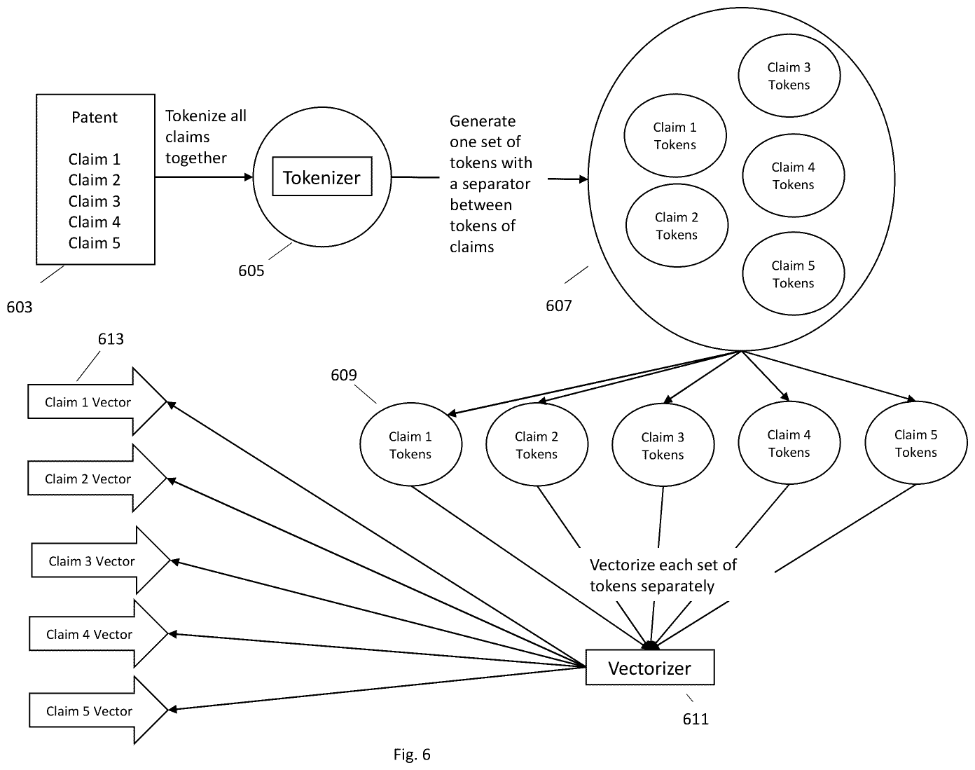

Source data from public and/or private data sets 513 (where applicable) is captured. The source data may include, without limitation, patent information sourced from global PTOs to support patent searching, R&D and other research-oriented use cases. The source data is parsed, tokenized, and converted into vectors 517 (e.g., using an embedding model, as described above). An illustrative block diagram of how patent claims may be vectorized is shown in FIG. 6, in accordance with an embodiment of the invention. In this example. forming the vectors may include late chunking. The claims of the patent 603 are tokenized all together by tokenizer 605. Tokenizer 605 breaks down the text of the claims 603 into tokens, assigning each token a numerical representation, or index, which can be used to feed into a model. The tokenizer 605 generates one set of tokens 607, with a separator between tokens of the claims 603. The tokens of each claim are separated out 609, and then passed to vectorizer 611, outputting claim vectors 613. Claim vectors 613 may be stored, optionally along with metadata from its associated patent, in a vector database.

Returning back to FIG. 5, the source vector database 517 may then be filtered according to the relevance 509 calculated by the query construction process, ranked by the recommendation engine 519, and loaded into the PIL 505 where the combined PIL information is available for inquiries via a LLM 523.

Users may query the LLM 523 via user interface 501, which is informed by the PIL 507, in natural language via a generative AI interface. Additionally, alerts and other reports updating the user with regard to the domain covered by the PIL 505 is available via the user interface 501.

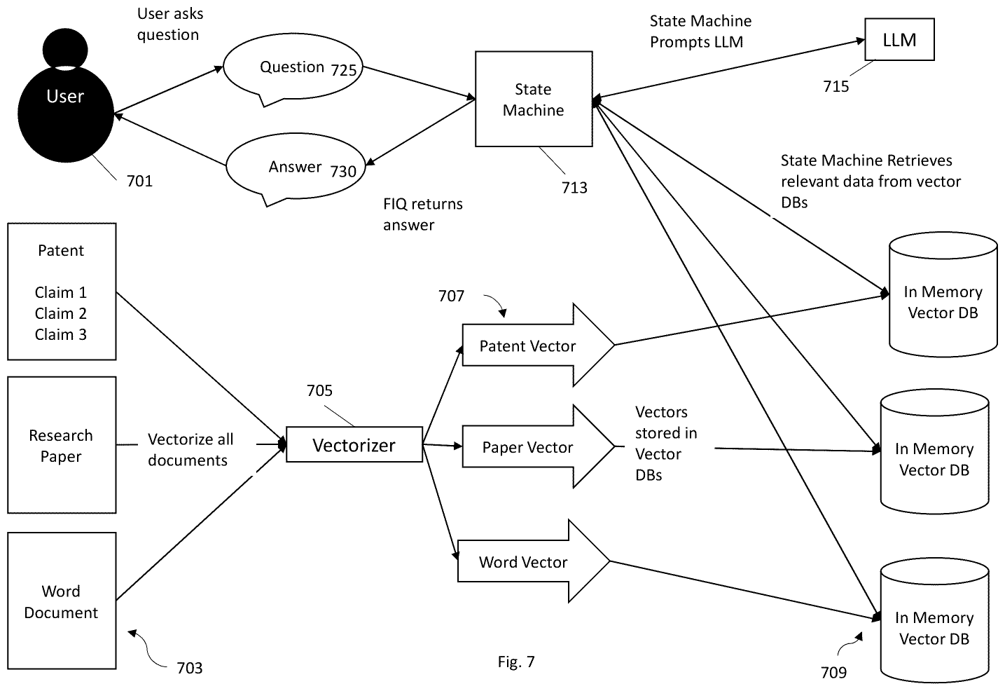

FIG. 7 shows a block flow diagram of a PIL interrogation 725 by a user 701, in accordance with an embodiment of the invention. The documents 703 in the PIL are passed to vectorizer 705, which outputs a vector 707 for each document. The resulting vectors 707 are stored in a vector database/memory 709. When the user 725 provides a query, a state machine/controller 713 prompts a LLM 715, which then retrieves relevant data from the vector database/memory 709 and provides an answer 730 back to the user 701.

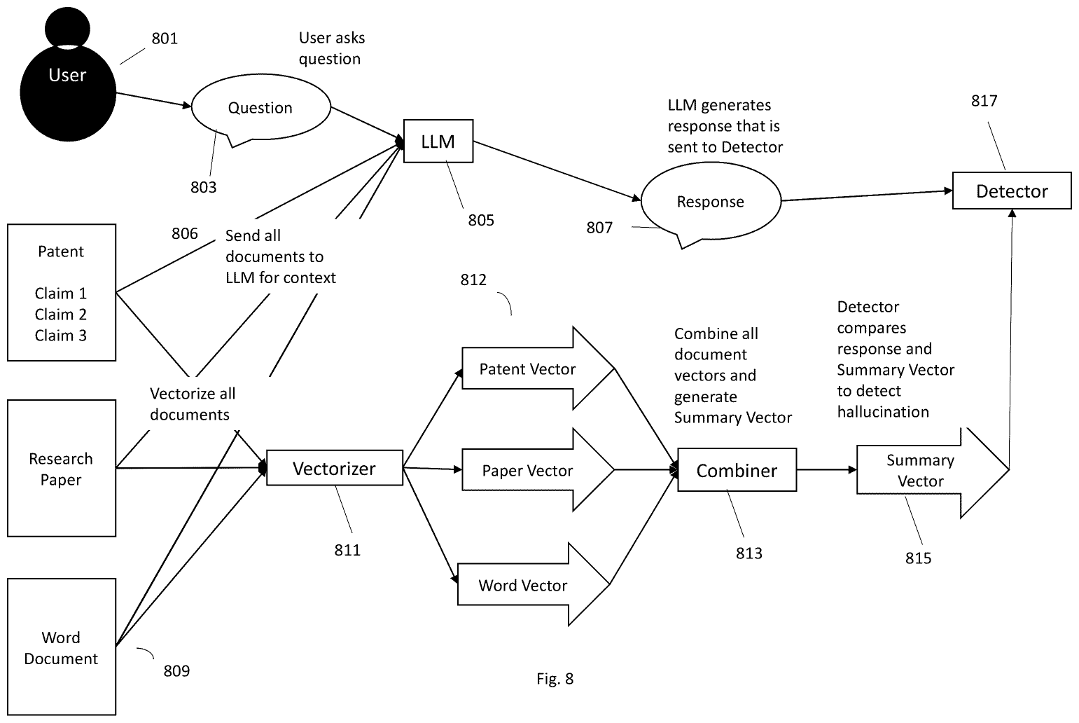

FIG. 8 is a block flow diagram of detecting hallucinations in a query response, in accordance with an embodiment of the invention. When a user 801 provides a query 803 to an LLM 805, the LLM 805 (which may have received the documents 806 in the PIL to assist in determine context of the query 803) generates a response 807. This response 807 may be a hallucination—i.e., the response is coherent and grammatically correct but factually incorrect or nonsensical. “Hallucinations” in this context means the generation of false or misleading information. These hallucinations can occur due to various factors, such as limitations in training data, biases in the model, or the inherent complexity of language. To help detect and prevent hallucinations, the documents in the PIL 809 passing thru a vectorizer 811 to provide vectors 812 of each document may be combined 813 into a single “summary” vector 815. A detector 817 may then compare the response 807 with the Summary Vector to detect the occurrence of a hallucination and may alert the system and/or user so they can take corrective action.

Returning back to FIG. 5, the user interface 501 may be available to the user and the user's outside experts to edit and update relevance indicators during the query construction process of the data sets 511. This step allows the user to fine tune queries that are otherwise automatically generated by the similarity engine 509 to eliminate noise and ensure accuracy.

The user interface 530 (which may be user interface 501) may also enable the user to curate rendered results from the target research datasets, in this example represented by a patent database. These curated rendered results will be summarized and loaded into the PIL to support further research inquires.

### EXAMPLES

Current patent searching tools require that users think of all the possible criteria in advance of a search and then use those criteria to author Boolean search strings, list keywords and synonyms for keywords. The result is often that the search itself returns too many results to practically review, and these are not organized in a fashion that simplifies and exposes the relevance of the search results. This requires searchers to hire outside experts to read and parse through each patent returned in the results, resulting in a time consuming and expensive process.

The PIL platform allows patent searchers (in this use case) to load the PIL (or PILs) with contextual information that will result in the systematic construction of a series of search strings based on a combination of the contextual information loaded into the PIL and the profile of the search project built into the PIL. These search strings will then pull relevant patent data from worldwide patent databases and load relevant information into the user's PIL. As a result, the PIL itself continues to evolve and becomes a dynamic innovation intelligence library for exclusive use by the user and the user's company.

Although the following examples are focused on patent searching use cases initially, it is to be understood that the PIL environment is not limited to patent searching, and may be used to build a curated domain-specific intelligence platform that is used to develop contextual searches that will query any other source of research data as defined by the product roadmap.

### Operational Use Cases

In the examples listed below, a PIL associated with a medical device manufacturer needs information that is related to their specific product features. Thus, there is no need to process the entire patent universe. While it may not be relevant to contain the entire patent universe on a per project basis, later use cases may require a more generic search.

### Use Case—Legal, Automated FTO Analysis

### Scenario A—Jane Has Been Engaged to Complete a Freedom to Operate Report for a Client

The scenario—Jane is an IP attorney who is engaged by a new client to perform an FTO analysis on their new products based on several patents that they have acquired through an acquisition. Jane's client operates in the medical device market and specializes in wearable devices provided by a doctor's prescription to their patients. The client has a wearable product that will monitor basic vital signs, such as respiratory rate, heart rate, temperature, pulse, etc. The client has asked Jane to complete a Freedom to Operate report to help them understand the risk of releasing new products to market and to ensure there are no risks associated with the existing patents they acquired.

Jane asks for the existing patent numbers, information about relevant competitors and specific product descriptions from internal documentation, including functional requirements. Jane also asks for any relevant medical journals or trade publications of interest to the client's market. Jane then has her staff create a project profile for her client and her client's specific product. The patents IDs are entered into the system as well as any relevant product documentation. All data, including articles, etc., are uploaded into the system and indexed. The patents are pulled from the jurisdictional PTOs, parsed, indexed and loaded as well. Claims from each patent are extracted, tagged, and stored for editorial review. The content from the profile/these documents now resides in the customer's Private Innovation Library (PIL).

Jane's staff also enter URLs from competitors into the system so that product features from their products, news releases and other relevant content can be indexed and loaded into their PIL. As updated information is loaded, as from a website, any update from those sources will continue to be processed and indexed. This functionality will have to be built into individual connectors using a third-party web crawler to identify and extract updates from these sources. The PIL system will construct relevant search strings based on the context of the search and project profile and then will conduct a patent universe search and pull additional patents into the PIL.

Once the client and project profiles are completed, the system will present Jane and her team with a list of patents from global jurisdictions ranked in order of relevance. Relevance is calculated by comparing functional claims within patents to the product documentation (i.e., the project profile) provided by Jane's customers and their existing patents. The list of patents will include granted patents as well as innovation claims outlined in open patent applications. These patents are ranked by relevance and separated by jurisdiction. Jane can sort the output by relevance, inventor name, assignee, jurisdiction and other criteria to help sort through the most relevant patents.

Jane is also able to sort patents by the functional claims outlined in the patents to help weed out patents related to irrelevant features. Patents and data that are deemed irrelevant are flagged and removed (yet may stored as “inactive”) from the PIL she has established for her customer. The relevant data is supplemented by market intelligence gleaned from public websites, news sources, journals, FDA filings, and other sources that were deemed relevant and loaded into the system as single artifacts (e.g., an article) or as a source of continuous data update (e.g., PTO or website).

After a series of request/response actions into the system to fine-tune the result set and sort out irrelevant information, Jane builds and exports a report to deliver to an outside expert who will help her render an opinion. Jane then writes an opinion letter and exports a summary report for her client from the PIL system.

Conclusion—Jane has converted a typical one-off FTO analysis and opinion process restricted to a point in time to one where she has access to dynamically updated market data in addition to specific IP related data from the various global patent jurisdictions. Her own analysis costs are lowered due to the automated nature of the process, reducing her need for outside search staff and lowering the cost of engaging outside experts. Most importantly, she has established a dynamic knowledge base in a digital library for her client's products and IP portfolio that will be continually updated from the various sources built into her client's profile. This will allow her to stay on top of critical changes in the market for her client through a series of alerts and as such can spend her time engaging them on risk advisory services, alert them to any potential infringements on their patents and provide other value-add advice and counsel.

### Scenario B—Jane Has Already Completed FTO and is Monitoring the Innovation Environment Related to Her Customer's Products

The scenario—The client has two patents already but has added features to the product that allow them to also monitor sugar levels and communicate regularly with a closed community of doctors, family members and other caregivers. Because Jane previously used the platform to produce the FTO analysis for the original patents secured by her client during the acquisition, Jane simply needs to understand how the landscape has changed for her client since the last FTO report was delivered to her client, which was several years prior after their acquisition. Her client's profile is already set up in the system and as such, Jane has been getting dynamic updates on market changes that could impact her client over the past two years and so is already up-to-speed on her client's competitive situation and the state of their IP related risk.

Jane updates the client profile to include the new features being added to the product by loading draft marketing materials and functional requirements provided by the client into the secure system. Once Jane refreshes the client's project profile, this new information is indexed by the system and new data is loaded into her client's Private Innovation Library (PIL) from PTOs and other sources determined previously to be relevant. This includes several new patents, new articles previously ignored from trade journals, websites and news sources because they were not relevant prior but are now due to the new product features. Jane also asks the client for any new competitors that should be considered because new features are being added. Given that the original product was brought to market several years ago, this might also include makers of other wearable devices that are not traditionally operating in the medical device space. The patents of these firms are also scanned by the system, indexed and loaded into their PIL.

Upon refreshing the PIL, new information is presented and flagged for her review by relevance. The existing relevance indicators for previously identified patents are updated as new patents are added to the library. New data is flagged so she can discern what information is related to the product's new functionality vs. information that was loaded and processed previously. This includes a variety of new patents that contain certain key words or phrases in the patent claims that could be linked to the new product features described by the customer and even includes potentially new competitors the client did not mention because they have open patent applications whose claims overlap with their own proposed product features. Jane reviews the material, engages with outside experts as required and updates her opinion letter to her customer.

The conclusion—Both Jane and her customer have saved money in this process because the entire FTO analysis was essentially kept up to date over the past two years by maintaining a project profile for her client's product in the system. As such, Jane has been able to help her client think about potential risks and opportunities related to their product since the last official opinion letter was provided two years prior. She has now become a trusted advisor to her client because of her ability to stay seamlessly and proactively up to date and engage them in timely ways, such as cease and desist actions against competitors who were rolling out products that overlapped with their patents.

Jane was also able to turn around the new FTO request much faster and more cost effectively because all she needed to do was review changes to the existing product landscape rather than start a completely new research project. Costs were further lowered, and time saved because she did not need to engage a third-party patent search firm to do the basic info gathering and analysis. Because Jane also leverages outside experts when writing her opinion letter, those experts were easier and more cost-effectively engaged because she could provide them with online access to relevant data and patents without the need for them or her staff to do new research and analysis related to the new product features.

### Use Case—Researcher, R&D

### Scenario A—R&D Analyst Needs Better Understanding of a Technological Landscape When Designing New Product Features for His Company's Industrial Products

The scenario—Manny is an engineer working in the R&D department of an industrial equipment company. He is trying to understand how the landscape for a particular technology is evolving. He knows he needs to add features to his products based on customer demands, but he needs to determine how to build out his product's capabilities without running afoul of any competitor's IP and he needs to make sure that his design matches industry standards.

Manny is only analyzing one particular feature in a broader product line. So, he selects product specification information and specific AMSE standards that are relevant to the product and loads them into the PIL. He is aware of a variety of patents owned by his competitors, so he loads the patent ID's into the PIL as well. Manny also loads specific trade journals into the PIL to make sure that updated context is leveraged when conducting his search. In addition to loading relevant information into the PIL, Manny creates a project profile within the PIL that outlines the main purpose of his research, being careful to describe both what features he is most interested in and which ones he is not interested in.

The PIL constructs a series of search strings based on the combination of the project's profile and the contextual information loaded into Manny's research library. Manny reviews these criteria and deletes a few that he thinks are redundant or less relevant. These queries are then applied to the patent data sets, and a series of patents are processed and ranked by relevance. Manny then could review the rendered results to ensure that only relevant information is extracted. These patent summaries are then uploaded into his PIL. Manny then completes his research by querying the related LLM and produces summaries that he includes in his research report to the head of product design.

The conclusion—Manny is able to parse out specific features from a complicated industrial product. Using a mix of internal information and external data that he knows is relevant to his product design, Manny is able to establish a rich contextual library about the topic, in this case a product feature, to support his ongoing product development planning. Manny is able to use the output from this process to support his reporting and importantly, has established a persistent source of information to support his ongoing product design efforts.

Embodiments of the invention may be implemented in whole or in part in any conventional computer programming language. For example, preferred embodiments may be implemented in a procedural programming language (e.g., “C”) or an object oriented programming language (e.g., “C++”, Python). Alternative embodiments of the invention may be implemented as pre-programmed hardware elements, other related components, or as a combination of hardware and software components.

Embodiments can be implemented in whole or in part as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Although various exemplary embodiments of the invention have been disclosed, it should be apparent to those skilled in the art that various changes and modifications can be made which will achieve some of the advantages of the invention without departing from the true scope of the invention.

What is claimed is:

1. A computer-implemented method of establishing and curating data, the method comprising:
maintaining a knowledge base in a digital library to support an information-based decision-making process; and
dynamically populating the knowledge base by:
using an embedding model for indexing a plurality of data sets; and
conducting at least one search over the plurality of data sets to identify one or more documents, the documents stored in the digital library.

2. The method according to claim 1, wherein conducting the at least one search is performed intermittently or periodically.

3. The method according to claim 1, further comprising:
receiving, from a user interface, a user project profile and/or documentation, wherein conducting the at least one search includes constructing a query over the plurality of data sets based on the contextual data associated with the user project profile and/or documentation.

4. The method according to claim 1, wherein conducting the at least one search includes utilizing contextual data from documents already stored in the digital library to construct a query over the plurality of data sets.

5. The method according to claim 1, further comprising receiving relevance indicators from a user interface, wherein conducting the at least one search includes fine tuning a query over the plurality of data sets based on the relevance indicators.

6. The method according to claim 1, wherein using an embedding model for indexing a plurality of datasets includes creating a single representative index of the documents stored in the digital library.

7. The method according to claim 1, further comprising:
utilizing a large language model (LLM) that interacts with a user interface to evaluate information stored within the digital library to ensure that data found by the searches is relevant to the contents of the digital library and/or aid in formation of queries.

8. A system for establishing and curating data, the system comprising:
a server configured to:
maintain a knowledge base in a digital library to support an information-based decision-making process; and
dynamically populate the knowledge base by:
using an embedding model for indexing a plurality of data sets; and
conducting at least one search over the plurality of data sets to identify one or more documents, the documents stored in the digital library.

9. The system according to claim 8, wherein the server configured to conduct the at least one search intermittently or periodically.

10. The system according to claim 8, wherein the server is further configured to:
receive, from a user interface, a user project profile and/or documentation, wherein conducting the at least one search includes constructing a query over the plurality of data sets based on the contextual data associated with the user project profile and/or documentation.

11. The system according to claim 8, wherein conducting the at least one search, the server is configured to utilize contextual data from documents already stored in the digital library to construct a query over the plurality of data sets.

12. The system according to claim 8, wherein the server is further configured to receive relevance indicators from a user interface, wherein conducting the at least one search includes fine tuning a query over the plurality of data sets based on the relevance indicators.

13. The system according to claim 8, wherein the server is configured to create a single representative index of the documents stored in the digital library.

14. The system according to claim 8, wherein the server is further configured to utilize a large language model (LLM) that interacts with a user interface to evaluate information stored within the digital library to ensure that data found by the searches is relevant to the contents of the digital library and/or aid in formation of queries.

15. A computer program product for establishing and curating data, the computer program product comprising a non-transitory computer usable medium having computer readable program code thereon, the computer readable program code comprising:
program code for maintaining a knowledge base in a digital library to support an information-based decision-making process; and
program code for dynamically populating the knowledge base by:
using an embedding model for indexing a plurality of data sets; and
conducting at least one search over the plurality of data sets to identify one or more documents, the documents stored in the digital library.

16. The computer program product according to claim 15, wherein conducting the at least one search is performed intermittently or periodically.

17. The computer program product according to claim 15, further comprising program code for receiving, from a user interface, a user project profile and/or documentation, wherein conducting the at least one search includes constructing a query over the plurality of data sets based on the contextual data associated with the user project profile and/or documentation.

18. The computer program product according to claim 15, wherein conducting the at least one search includes utilizing contextual data from documents already stored in the digital library to construct a query over the plurality of data sets.

19. The computer program product according to claim 15, further comprising program code for receiving relevance indicators from a user interface, wherein conducting the at least one search includes fine tuning a query over the plurality of data sets based on the relevance indicators.

20. The computer program product according to claim 15, wherein using an embedding model for indexing a plurality of datasets includes creating a single representative index of the documents stored in the digital library.

21. The computer program product according to claim 15, further comprising program code for utilizing a large language model (LLM) that interacts with a user interface to evaluate information stored within the digital library to ensure that data found by the searches is relevant to the contents of the digital library and/or aid in formation of queries.
